(19) United States
(12) Patent Application Publication
(10) Pub. No.: US 2022/0202033 A1
(43) Pub. Date: Jun. 30, 2022

(54) Cold Brew Tea Method of Producing Kombucha

(71) Applicants: Michael Ryan Eliot, Bend, OR (US); Kristine Teresa Romaine, Bend, OR (US)

(72) Inventors: Michael Ryan Eliot, Bend, OR (US); Kristine Teresa Romaine, Bend, OR (US)

(21) Appl. No.: 17/137,250

(22) Filed: Dec. 29, 2020

(51) Int. Cl. A23F 3/18; A23F 3/14; A47J 31/18

(52) U.S. Cl. CPC A23F 3/18; A47J 31/18; A23F 3/14

(57) ABSTRACT

The present invention relates to a method for producing beverages, more particularly, the present invention relates to a method for producing a kombucha tea drink from the Camellia sinesis plant. Traditionally, kombucha tea is prepared through a practiced fermentation method that consists of the fermentation of black tea, dissolved in sugar, in a symbiotic culture of yeast and bacteria (Scoby). Considering the immense antioxidants and benefits of kombucha, it is crucial to not reduce any of these properties through preparation with hot water that could destroy key benefits. In this regard, embodiments of the present invention comprise a method of making a tea-based fermented drink, comprising steps of preparing the tea leaves picked from a plant source; preparing the water with temperature not greater than 80 degrees Fahrenheit (F); adjusting the water temperature to 40 degrees F. or less for a brewing temperature range of 33-40 degrees F.; adding the water to a vessel; preparing a brew tea concentrate using tea bags or loose tea at a brewing temperature range of 33-40 degrees F.; adding the tea concentrate to the water available in the vessel; mixing the mixture of tea concentrate and water; adjusting the temperature of the mixture to 33-40 degrees F.; adjusting the temperature of a cold storage to 33-40 degrees F.; and cold brewing the mixture by placing the mixture in the cold storage for at least 2 hours up to 5 days

### CROSS-REFERENCE TO RELATED APPLICATIONS

No related applications are previously filed.

### TECHNICAL FIELD OF THE INVENTION

The present invention relates to a method for producing beverages, more particularly, the present invention relates to a method for producing a kombucha tea drink from the Camellia sinesis plant.

### BACKGROUND OF THE INVENTION

Tea is considered one of the most popular non-alcoholic beverages all over the world. Tea decoction is the most preferred method of preparing tea, and it primarily entails boiling of tea in hot water or milk. Historically, hot tea infusion has been known for improving moods, detoxication, improving cognition ability, disease prevention, and blood flow. Through the phytochemical screening, tea has been identified to contain more than 700 chemicals such as tannins, polyphenols, amino acids, etc. Antioxidants are some of the most useful tea chemicals as they are beneficial in health since they protect cells from free radical damage, thus controlling stress and aging. However, recent studies have established that the hot preparation of tea results in damage to some of the useful components of tea. It has been found that heating deactivates essential bioactive and temperature-sensitive molecules such as flavonoids in tea. Additionally, heating of the tea increases tannins, which greatly increases astringency in flavor. This is one of the most common complaints about kombucha. People are deterred by the sharp, vinegary astringent flavor and will not consume this highly beneficial beverage due to the off-putting taste commonly associated with kombucha.

The earliest reference to kombucha tea fungus dates back to 221BC, in China's Tsin Dynasty. kombucha tea was discovered by pastor Weidenger, a missionary in Taiwan. It was called ‘elixir of long life,’ meaning ‘the divine Tsche,’ Tsche was the word for tea. It later found its way into Korea with and in AD14, it was used by Kombu, a Korean medicine man, in treating disorders of Inkyo, the Japanese emperor. For kombucha's name, research by pastor Weidenger suggests that the tea was named after the Kombu, the Korean medicine man, and ‘cha,’ the Chinese word for tea, hence ‘kombucha’. Its preparation entails the fermentation of boiled tea in a culture of bacteria and yeast in a sugary medium.

The increased demand for fermented beverages has led to bottling and kegging of beverages for convenient retail trade in such locations as grocery stores, restaurants, filling stations, businesses, and even as home kegerators. However, the basic sale methods have remained unchanged for centuries for non-alcoholic beverages with minimal changes in the style of serving. Many restaurants, brew pubs, and bars throughout the nation opt to serve non-alcoholic beverages besides a sugary soda pop. Legal restrictions on the amount of alcohol that one can consume at a given instant and general safety concerns have significantly resulted in nonalcoholic beverages' preference. As a result, accidents related to alcohol drinking and driving have greatly reduced in the recent past. Kombucha tea is a common non-alcoholic beverage an equally perfect beverage choice for both healthy lifestyle purposes and as an alternative to alcoholic beverages.

The making of the kombucha tea begins with the production of sweet tea and then transforming it into hot steeped black tea though the addition of sugar and allowing it to cool to room temperature. A “symbiotic culture of bacteria and yeast” known as an acronym called a SCOBY (Scoby) is then introduced in the concoction. Though there are many and varying methods in preparing and brewing kombucha, the basics still remain relatively the same. One must have the Scoby and the starter solution (mother tea). The recipe consists of but is not limited to 1 gallon of water, 1 cup of sugar, and six tea bags or equivalently loose-leaf tea. The preparation entails boiling the water in a large pot, adding the tea bags, turning off the heat, and adding sugar and stirring until the sugar is fully dissolved. The teabags are allowed to steep for about 10-20 minutes in hot water and then removed or strained depending on personal preference. The sweet tea is allowed to cool to room temperature, and a cup of the starter tea from a previous batch of kombucha or from a reliable source is added; then the Scoby is also added and the covered and cultured for 7-30 days at room temperature.

Sugar and energy are necessary for the metabolism process in kombucha preparation. Sugar has to be added as the culture does not provide its own. The sugar is mainly consumed in the respiration process, where it is broken down into minerals, vitamins, acids, carbon dioxide, and enzymes (Soto et al., 2018). When the process is done correctly, the sugar converts fully, producing the sour vinegary, and sometimes a bitter effervescent beverage known as kombucha. Other than in preparing the tea, sugar is also essential for the propagation of the kombucha culture. Minerals and nitrogen are also necessary for the metabolism process, but the tea itself provides these.

The kombucha tea fermentation cycle results in the production of alcohol as a by-product. Yeast plays the primary role of converting sugar into alcohol, while the natural bacteria convert much of the alcohol into organic acids, such as acetic acid. For commercial purposes, the content of alcohol must remain below 0.5% alcohol by volume (ABV). Kombucha is therefore sold as a non-alcoholic beverage. Nonetheless, manufacturers have reverted to produce an alcohol-based version with raised alcohol level but within the guidance from states and federal governments.

As detailed above, kombucha tea traditionally is prepared through a practiced fermentation method that consists of the fermentation of black tea, dissolved in sugar, in a symbiotic culture of yeast and bacteria (Scoby). The Scoby is bell-shaped and is also known as ‘tea fungus”. The tea has a sweet sparkling cider taste when freshly prepared but turns into a vinegar-like acidic flavor when fermented for a long duration. Acetobacter xylinoides, Komagataeibacter xylinus, Gluconacetobacter xylinus, Acetobacter aceti and Acetobacter pasteurianus are the main strains of bacteria traitionaly used in the Scoby. Schizosaccharomyces pombe, Saccharomycodes ludwigii, Kloeckera apiculate, Saccharomyces cerevisiae, Torulaspora Zygosaccharomyces bailii, Brettanomyces bruxellensis, Brettanomyces lambicus, Brettanomyces custersii, Candida and Pichia are common yeast species in the Scoby. The Acetobacter species are claimed to form the cellulosic network that gives the physical base for the symbiotic development.

Kombucha is associated with a myriad of nutritional benefits as it possesses the characteristics of functional food. From its beginning, it gained popularity as a detoxifier, energizer, and curative to digestion problems. It contains liver detoxifiers, probiotics, polyphenols, antioxidants, and free-form amino acids (Kumar & Joshi, 2016). It has historically been used as an alternative therapy for many diseases. Its continued consumption is also attributed to the prevention of a few cancers, asthma, allergies, hemorrhoids, treatment of insomnia, arthritis, increase of T-cell count, increase of vitality, and simulation of hair regrowth (Dutta & Paul, 2019). The tea is also believed to boost the immune system and hence increasingly popular amongst the aging populations. The beverage is claimed to be a prophylactic agent and useful to human health as a diuretic in edemas, in atherosclerosis, stones, sluggish bowels and in cases of gout etc. The fermentation also induces the biosynthesis of ascorbic acid. Kombucha contains Vitamin C, which is naturally an antioxidant and thus, a drug and a health protector. When brewed carefully, kombucha tea contains reduced tannins and increased ascorbic acid, thus useful in iron absorption and in improving digestion. Kombucha can be used as a protein supplement in animal feeds due to its richness in biomass. It also has small traces of useful minerals such as zinc, lead, manganese, iron, copper, nickel, cobalt, chromium, and cadmium. β-glucuronide is an important bacterium that acts as an enzyme that has interference with the chemotherapeutic agent's proper disposal and as an antibiotic to gut bacteria, thus preventing the toxicity of certain therapy drugs.

Nutrition can be a tricky thing—we are always looking for the next big beneficial superfood or drink. One of the most popular health drinks in the world today is tea because it has numerous benefits for the body when consumed in regulated quantities. It is rich in anti-inflammatory properties, has elements that help you relax, and overall is full of rich antioxidants and blood purifying agents.

Regardless of what kind of tea you have whether it be an herbal tea, a true tea, or a fruity tea, heating it will take away from its medicinal properties. Some of the compounds found in tea are known to be volatile. Which, in simple terms, means that these compounds are unstable and may vaporize when subjected to excessive heat. This happens during the initial preparation of tea. The essential oils in tea, for example, are known to be volatile. This means it is highly likely that by heating the tea, it will lose much of its unique aroma. Other compounds found in the tea and herbs are known to be labile. These elements are highly likely to break down in the presence of heat. There are many different chemical reactions that take place inside of a cup of tea and there is certainly room for more research.

Because of the tendency for heat to destroy tea's therapeutic value, we began searching for a method that would retain it's powerful properties. As tea drinkers, most of us know that the water temperature we use to brew along with steeping time can make or break a cup. Some leaves can be finicky, others risk bitterness if we let them steep too long. Not so with cold brewed tea! Brewing tea in cold water removes all chances at bitterness or an unpleasing taste.

When you make tea with cold water it allows for fewer tannins to draw into the cup while steeping, leaving a smoother, fresher flavor and no risk of unsavoriness—regardless of how long to leave the leaves to steep. For the best brew, leaving teas overnight gives the tastiest results, though, for those in a hurry, leaves can be left for even just 4-6 hours and still give great flavor.

There has been a global trend toward the use of phytochemicals present in natural resources as antioxidants and functional foods. Bioactive molecules of natural resources are being utilized in the food industry, and there is evidence that these molecules can act as antioxidants within the human body. The antioxidant activity of kombucha is correlated with its many claimed beneficial effects like cancer prevention, immunity enhancement, and alleviation of inflammation and arthritis. Jayabalan and others (2008a) reported on the free radical scavenging abilities of kombucha tea prepared from green tea, black tea, and tea waste material. They have shown that total phenolic compounds, scavenging activity on DPPH radical, superoxide radical, and inhibitory activity against hydroxyl radical-mediated linoleic acid were increased with an increase in fermentation time, whereas reducing power, hydroxyl radical scavenging ability (ascorbic acid-iron EDTA), and antilipid peroxidation ability were decreased. Malbaša and others (2011) studied the influence of 3 starter cultures (mixed culture of acetic bacteria and Zygosaccharomyces sp., mixed culture of acetic bacteria and Saccharomyces cerevisiae, and native local kombucha) on the antioxidant activities of green tea and black tea kombucha beverage to hydroxyl and DPPH radicals. They observed the highest antioxidant activity with native kombucha on green tea beverage and acetic acid bacteria with Zygosaccharomyces sp. culture on black tea beverage. The antioxidant property of kombucha tea was tested against tertiary butyl hydroperoxide (TBHP)-induced cytotoxicity using murine hepatocytes and showed that kombucha tea neutralized the TBHP-induced changes and prevented cell death. These counter effects were also shown by the unfermented black tea, but the kombucha tea was found to be more efficient.

The antioxidant activity of kombucha tea is due to the presence of tea polyphenols, ascorbic acid, and D-saccharic acid-1,4-lactone (DSL). Kombucha tea was observed to have higher antioxidant activity than unfermented tea and that may be due to the production of low molecular-weight components and structural modifications of tea polyphenols by enzymes produced by bacteria and yeast during fermentation. Kombucha exhibited increased free radical scavenging activities during fermentation. The extent of the activity depended upon the fermentation time, type of tea material, and the normal microbiota of the kombucha culture, which in turn determined the nature of their metabolites. Although free radical scavenging properties of kombucha showed time dependent profiles, prolonged fermentation is not recommended because of accumulation of organic acids, which might reach harmful levels for direct consumption. The identification of extracellular key enzymes responsible for the structural modification of components during kombucha fermentation and potent metabolites responsible for the free radical scavenging abilities are necessary to elucidate the metabolic pathway during kombucha fermentation. Metabolic manipulations may be one of the effective methods to enhance the antioxidant activities and fermentation efficiency of kombucha.

Probiotics are known to be living microorganisms; when administrated in adequate amounts, they are able to result in health benefits. Most often, the bacterial component of a probiotic mixture comes from Lactobacillus or Bifidobacterium or a cocktail of these two strains. In support of these lines, there can be a few common yeast types such as Saccharomyces boulardii and S. cerevisiae in this mixture as well. Probiotic microbes are known to play a vital role in the wellness of human health. Probiotic microorganisms provide a balance in intestinal microbiota, normalizing processes in gut and boosting the immune system. In addition, they help in improving digestion, fighting against harmful bacterial overgrowths, and achieving mental clarity and mood stability and against psychological conditions such as anxiety and depression.

Many studies have claimed that this beverage not only is a probiotic but also acts as a symbiotic, a combination of prebiotics and probiotics. A prebiotic selectively helps the growth and activity of the consortium of beneficial microbes present in the human gut. The bacteria and yeast present in this beverage act as probiotics and the microcellulose which is present can help in the growth of the beneficial microbes present in the intestine. The popularity of this beverage as a probiotic and a symbiotic has increased in recent times as scientists have found that this beverage can be used to give the required nutrition and help maintain health and wellness in humans who work under unhealthy environments, such as workers in mines and polar expeditors. When the human body is exposed to such conditions for a prolonged period of time, the normal microbial consortium of microbes in the intestine changes due to the unnatural conditions, psycho-emotional discomfort, and drastic change in the diet. This may lead to the disappearance of the protective gut microbes and the emergence of harmful secondary infections by opportunistic microbes. This shift in the gut microbiota can lead to many health issues such as allergies, autoimmune diseases, multiple sclerosis, and transplant infectious disease. The change in the gut microbiota can be corrected to some extent with the help of Kombucha tea. In light of these mentioned possibilities, scientists have started to consider this beverage to be used by astronauts as a supplement to their diet in outer space. Because of the immense antioxidants and benefits of kombucha, it is crucial to not reduce any of these properties through preparation with hot water that could destroy key benefits. Our cold brew method protects these properties for maximum nutritional use and absorption by the body.

None of the prior art inventions and patents, taken either alone or in combination, is effective to overcome the identified defects of providing an appropriate method that can address the issues of kombucha production as discussed above. Additionally, none of the prior art inventions and patents, taken either alone or in combination, is effective to overcome drawbacks of traditional kombucha production.

Hence, the present invention proposes to resolve the existent technical difficulties to eliminate the shortcomings of prior art. The present invention provides a unique method of cold steeping tea in the production or manufacturing of kombucha tea.

### SUMMARY OF THE INVENTION

Embodiments of the invention solve the above-mentioned problems by providing a unique a unique method of making kombucha that satisfies the flavor profile for the end user or consumer. The invention provides the process of cold steeping tea in the production or manufacturing of kombucha tea. The tea (Camellia Sinensis) comes in hundreds of varieties, but the most common tea for the production of kombucha is, but not limited to, black tea, green tea, Oolong tea and/or white tea; also notable is a blend of teas. Blending tea is the combination of different teas together to achieve the flavor profile of the final kombucha product. Such tea blends may combine others from the same cultivation area or several different ones. The result is to obtain consistency, maximum nutritional impact and better tasting kombucha. The variety of tea used is not the differing factor of this invention; it is the preparation of the tea, which all come from the Camellia sinesis plant.

Cold brew tea is made using water not greater than 80 degrees Fahrenheit (F). It is then brought to 40 degrees F. or less for a brewing temperature range of 33-40 degrees F. There are several means to achieve this temperature and it is not limited to simply placing in refrigeration. The tea can be made in a vessel and transferred into refrigerated cold storage. A glycol chiller and a jacketed stainless-steel tank also complete the task of cooling the tea in the cold brewed or steeping process. The glycol chiller would chill the water and lines leading to the jacketed tank. Chilled glycol is circulated through a cooling jacket to control temperature in the tank that houses the tea. A cold brew tea concentrate may be made ahead of time using the above temperature parameters and then added to a vessel of chilled water at 33-40 degrees F.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

Embodiments of the invention are described in detail below with reference to the attached drawing figures, wherein:

FIG. 1 is a step wise flow chart providing steps involved in the method of producing a kombucha tea drink.

FIG. 2 is a pictorial representation of the method of producing a kombucha tea drink.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

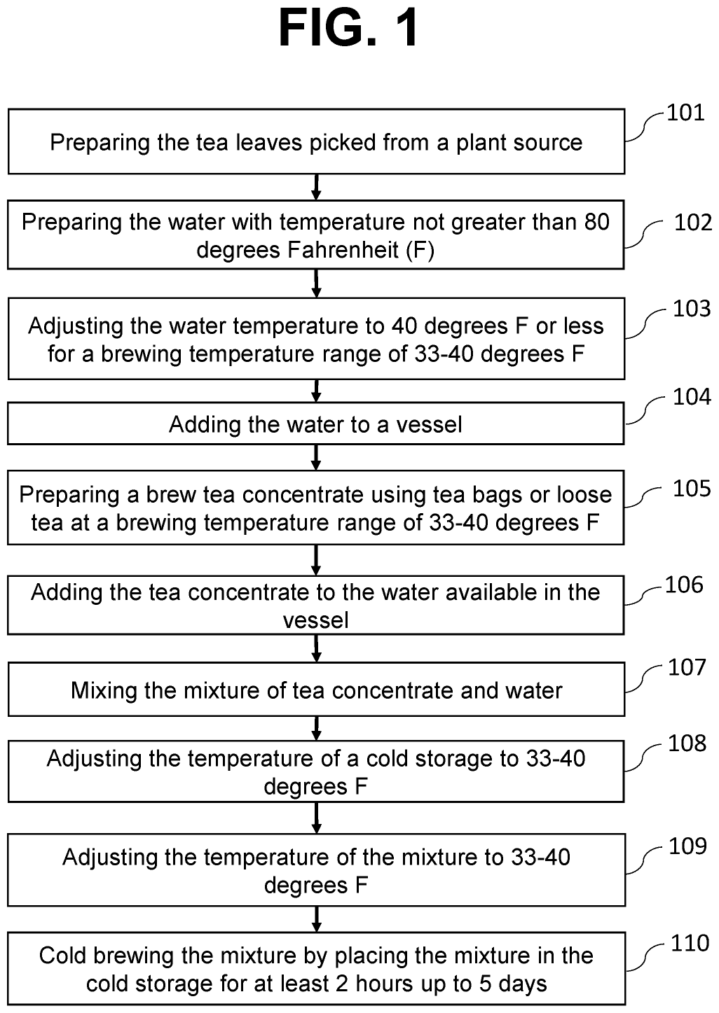

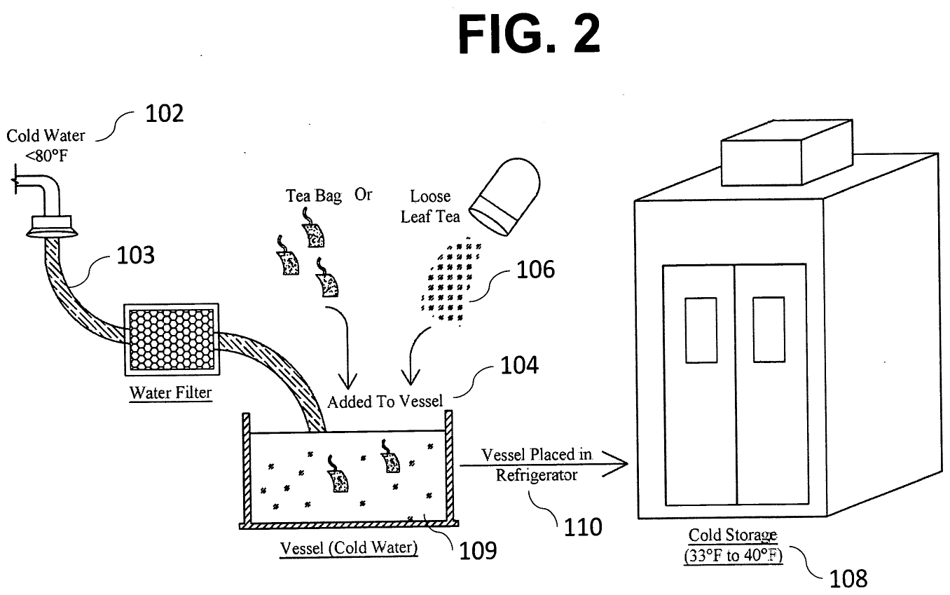

Turning to the figures and specifically FIG. 1 and FIG. 2, embodiments of the present invention comprise a method of making a tea-based fermented drink, comprising steps of preparing the tea leaves picked from a plant source 101; preparing the water with temperature not greater than 80 degrees Fahrenheit (F) 102; adjusting the water temperature to 40 degrees F. or less for a brewing temperature range of 33-40 degrees F. 103; adding the water to a vessel 104; preparing a brew tea concentrate using tea bags or loose tea at a brewing temperature range of 33-40 degrees F. 105; adding the tea concentrate to the water available in the vessel 106; mixing the mixture of tea concentrate and water 107; adjusting the temperature of the mixture to 33-40 degrees F. 108; adjusting the temperature of a cold storage to 33-40 degrees F. 109; and cold brewing the mixture by placing the mixture in the cold storage for at least 2 hours up to 5 days 110.

In one embodiment of the present invention, the plant source is Camellia sinesis.

In another embodiment of the present invention, the method of adjusting the water temperature is by placing the water in a means that enables water to be stable at a temperature range of 33-40 degrees F.

In the same embodiment of the present invention, the means that enables water to be stable at a temperature range of 33-40 degrees F. are a glycol chiller and a jacketed tank wherein the said glycol chiller chills the water and lines leading to the jacketed tank and chilled glycol is circulated through a cooling jacket to control temperature in the tank that houses the tea.

In the same embodiment of the present invention, the method of preparing the brew tea concentrate consist of, but not limited to, Cold Soaking, Cold Infused, Cold Brewed, Cold Steeping or the action of pumping over, percolating; such as in a vessel filled with the desired amount of non-chlorinated cold water, a pump can be used to draw off water from the bottom of the tank and recycled back on top through a diffuser.

In the same embodiment of the present invention, the length of time the mixture is allowed to cold brew is in accordance with the preparer's desired strength, flavor and types of teas used.

In the same embodiment of the present invention, if the mixture is left longer than 72 hours, it will need to have kombucha or vinegar added to reduce the pH to less than 4.0 to protect the brew from growing any unwanted bacteria.

In the same embodiment of the present invention, the vessels that are be used when making the cold brew tea are, but not limited to, a stock pot tub made of a high grade stainless steel, tanks, glass jars, plastic vessels of a food grade nature, from a 5 gallon plastic bucket up to an intermediate bulk container tote used in commercial food packaging and manufacturing.

Although embodiments of the invention have been described with reference to the embodiments illustrated in the attached drawing figures, it is noted that equivalents may be employed and substitutions made herein without departing from the scope of the invention as recited in the claims.

Having thus described in various embodiments of the invention, what is claimed as new and desired to be protected by Letters Patent includes the following:

1. A method of making a tea-based fermented drink, comprising steps of preparing the tea leaves picked from a plant source;
preparing the water with temperature not greater than 80 degrees Fahrenheit (F);
adjusting the water temperature to 40 degrees F. or less for a brewing temperature range of 33-40 degrees F.;
adding the water to a vessel;
preparing a brew tea concentrate using tea bags or loose tea at a brewing temperature range of 33-40 degrees F.;
adding the tea concentrate to the water available in the vessel;
mixing the mixture of tea concentrate and water;
adjusting the temperature of the mixture to 33-40 degrees F.;
adjusting the temperature of a cold storage to 33-40 degrees F.; and
cold brewing the mixture by placing the mixture in the cold storage for at least 2 hours up to 5 days.

2. The method of claim 1, wherein the plant source is Camellia sinesis.

3. The method of claim 1, wherein the method of adjusting the water temperature is by placing the water in a means that enables water to be stable at a temperature range of 33-40 degrees F.

4. The method of claim 3, wherein the means that enables water to be stable at a temperature range of 33-40 degrees F. are a glycol chiller and a jacketed tank wherein the said glycol chiller chills the water and lines leading to the jacketed tank and chilled glycol is circulated through a cooling jacket to control temperature in the tank that houses the tea.

5. The method of claim 1, wherein the method of preparing the brew tea concentrate consist of, but not limited to, Cold Soaking, Cold Infused, Cold Brewed, Cold Steeping or the action of pumping over, percolating; such as in a vessel filled with the desired amount of non-chlorinated cold water, a pump can be used to draw off water from the bottom of the tank and recycled back on top through a diffuser.

6. The method of claim 1, wherein the length of time the mixture is allowed to cold brew is in accordance with the preparer's desired strength, flavor and types of teas used.

7. The method of claim 1, wherein if the mixture is left longer than 72 hours, it will need to have kombucha or vinegar added to reduce the pH to less than 4.0 to protect the brew from growing any unwanted bacteria.

8. The method of claim 1, wherein the vessels that are be used when making the cold brew tea are, but not limited to, a stock pot tub made of a high grade stainless steel, tanks, glass jars, plastic vessels of a food grade nature, from a 5 gallon plastic bucket up to an intermediate bulk container tote used in commercial food packaging and manufacturing.
